(19) United States
(12) Patent Application Publication
(10) Pub. No.: US 2023/0036550 A1
(43) Pub. Date: Feb. 2, 2023

(54) Method For Frying A Foodstuff With Permeabilized Cell Membranes And Device For Producing A Fried Foodstuff

(71) Applicant: ELEA SERVICE GMBH, Quakenbrück (DE)

(72) Inventors: Kevin Hill, Osnabruck (DE); Robin Ostermeier, Osnabruck (DE); Stefan Topfl, Osnabruck (DE)

(21) Appl. No.: 17/791,587

(22) PCT Filed: Jan. 29, 2021
(86) PCT No.: PCT/EP2021/052109

§ 371 Date: Jul. 8, 2022

(30) Foreign Application Priority Data
Jan. 31, 2020 (DE) 10 2020 201 191.5

(51) Int. Cl. A23L 19/18; A23L 19/00; A23L 5/10; A23L 5/20; A23L 5/30; A47J 37/12

(52) U.S. Cl. CPC A23L 19/18; A23L 5/11; A23L 5/20; A23L 5/30; A23L 19/03; A47J 37/1266

(57) ABSTRACT

A method for frying a foodstuff (2) is shown, the cell membrane of which has been permeabilized, wherein the temperature of a frying medium (4) surrounding the foodstuff (2) is lowered from a starting temperature (8) at the beginning of the frying process to a final temperature (9) in a manner controlled in accordance with a predetermined temperature profile (7). Furthermore, a device (1) for producing a fried foodstuff (2) is shown, in particular for performing the above method, which comprises at least one frying container (3) for receiving a frying medium (4) and the foodstuff (2) to be fried, at least one temperature control device (5) for setting the temperature of the frying medium (4) in the frying container (3), and a control unit (6). in which a temperature profile (7) with a starting temperature (8) and a final temperature (9) below the starting temperature (8) is stored, wherein the control unit (6) is adapted to send temperature signals (10) to the at least one temperature control device (5) and thereby set the temperature of the frying medium (4) in the frying container (3) in accordance with the temperature profile (7).

The present invention relates to a method for frying a foodstuff in a frying medium surrounding the foodstuff.

The present invention furthermore relates to a device for producing a fried foodstuff, in particular for performing the method according to the invention, which device comprises at least one frying container for receiving a frying medium and the foodstuff to be fried, at least one temperature control device for setting the temperature of the frying medium in the frying container, and a control unit designed to transmit temperature signals to the at least one temperature control device and thereby to set the temperature of the frying medium in the frying container.

Frying is a cooking process wherein water-containing food is completely submerged in a frying medium, in most cases edible oil or fat. Frying media have a high heat capacity and can transmit heat to the food at temperatures far above the boiling point of water. The water bound in the food is step-by-step directed from the inside to the boundary layer as a consequence of the evaporation in the boundary zone to finally be discharged to the surrounding oil more or less quickly depending on the structure of the crust. If no more water is transferred from the inside of the food to the boundary layer, the temperature of the food increasingly rises to above 100° C. from the outside to the inside. The formation of the typical frying flavor and taste begins.

When the temperature rises to more than 120° C. in the boundary zone as a consequence of decreasing moisture, in particular in wheat and potato products, the formation of acrylamide can start when reducing sugar and asparagine are present. The formation of acrylamide can be clearly minimized by a preferably short frying duration at not too high temperatures. As the frying time increases, the foodstuff moreover absorbs increasingly more frying medium. However, the fat or oil absorption should be restricted to a preferably low degree for health and taste reasons.

Fat absorption is particularly high when an explosive boiling occurs when the foodstuff is introduced into the frying medium. As a consequence, the vapor pressure in the foodstuff will blow up the cell walls, so that large pores are formed which will fill with fat as the water content decreases. To minimize fat absorption, CH 620576 provides to fry potatoes initially at a constant temperature of 135 to 150° C., and to only allow the frying temperature to rise to 175° C. after they have been transported to another zone. The potatoes are treated, directly after they have exited the fat bath, with overheated vapor at a minimum temperature of 100° C. This solution requires a lot of equipment and extends the frying time since the foodstuff is initially fried at relatively low temperatures.

In order to avoid an explosive boiling, the cell walls of the foodstuff can be permeabilized before frying. Permeabilization can be accomplished by adding a permeabilization agent, by controlled pressure and/or temperature action, or by electroporation.

The technical realization of a method for frying permeabilized foodstuff or a device for performing such a method, however, are problematic. Potatoes which have been permeabilized by means of PEF can only be employed in deep friers to a restricted degree. The initially high temperature of the frying medium decreases surprisingly more sharply than common with permeabilized foodstuff, and the temperature only rises again with a delay and slowly after the evaporation of the major part of the water. Thereby, depending on the deep frier employed and on the heating power, the frying time will possibly extend, and due to the slower heating time, the formation of undesired, thermally induced side products, such as acrylamide, is promoted, and more frying medium is absorbed by the foodstuff.

The objective technical problem of the present invention is thus to provide a method and a device for frying permeabilized foodstuff.

The object is achieved, according to the invention, by a method for frying a foodstuff the cell membrane of which has been permeabilized,wherein the temperature of a frying medium surrounding the foodstuff is lowered from a starting temperature at the beginning of the frying process to a final temperature in a manner controlled in accordance with a predetermined temperature profile.

The object is furthermore achieved by a device for producing a fried foodstuff, in particular for performing the method according to the invention, which device comprises at least one frying container for receiving a frying medium and the foodstuff to be fried, at least one temperature control device for setting the temperature of the frying medium in the frying container, and a control unit in which a temperature profile with a starting temperature and a final temperature below the starting temperature is stored, wherein the control unit is adapted to transmit temperature signals to the at least one temperature control device and thereby to set the temperature of the frying medium in the frying container in accordance with the temperature profile.

The present invention promotes the frying of a foodstuff the cell membrane of which has been permeabilized before frying. A foodstuff the cell membrane of which has been permeabilized before frying is, however, problematic with respect to the frying process, as illustrated in the beginning. However, it surprisingly turned out that the controlled lowering of the temperature of the frying medium in accordance with a predetermined temperature profile prevents an undesired formation of acrylamide and a high absorption of the frying medium in a permeabilized foodstuff.

Frying media include fats, fatty oils, that means edible fat or edible oil, also referred to as frying fat or frying oil. If the temperature of the frying medium is controlled, that means is lowered by open or closed-loop control in accordance with a predetermined temperature profile, in particular the surprisingly high temperature drop at the beginning of the frying process can be compensated, and the temperature of the frying medium can be purposefully and quickly set to the desired starting temperature. In the device according to the invention, a control unit, for example, an open-loop or closed-loop control unit, is provided, which controls the at least one temperature control device and sets the temperature of the frying medium in the frying container in accordance with the temperature profile, that means lowers it in a manner controlled in accordance with the temperature profile. A temperature profile is to be understood as a temporal and/or spatial march of temperature.

The foodstuff can be, in a particularly effective manner, subjected to an electric field and be electroporated in this manner. In electroporation, the cell membrane becomes temporarily (reversibly) or permanently (irreversibly) permeable by applying an electric field. The applied electric field can moreover cause a controlled cell disruption wherein the degree of cell disruption is adjusted to a predetermined value. Electroporation is insofar advantageous as it is a nonthermally acting method wherein no heating in the sense of ohmic heating takes place and no substantial thermal changes of the ingredients are invoked. Electroporation, in particular by the action of pulsed electric fields (PEF), leads to a cell disruption involving an accelerated water discharge during drying or frying. This leads to a quicker drying and, in the manufacture of snack products, to an improved crispness. However, electroporation surprisingly also has disadvantageous effects on frying as a sharp temperature drop occurs in the frying medium unexpectedly when water is discharged too quickly due to the energy required for the evaporation. An essential advantage of the PEF method is an improved cutting behavior, in particular with vegetable products. This is advantageous in particular in the manufacture of foodstuff such as crisps, since a smoother cut and a reduced wear of the knife are the consequence of the cell disruption. The smoother cut moreover results in a lower release of ingredients, for example starch in case of potato products, and thereby a higher product yield and reduced efforts for cleaning the process water. The foodstuff fried according to the invention can in particular be a snack product. Snack products are preserved foodstuffs that represent a light meal, that means an in-between meal, and are often offered as a finger food packed ready-to-eat. Examples of snack products are nibbling products, such as potato crisps or other crisps, for example vegetable or sweet potato crisps. The method according to the invention and the system according to the invention can also be employed for frying other foodstuff, for example French Fries.

Below, further developments of the invention are described which can be arbitrarily combined with each other independently and are each advantageous taken alone.

According to one embodiment of the method according to the invention, the foodstuff can be fried continuously and be moved in a moving direction through at least two zones of different temperatures of the frying medium in the process. To this end, a frying container can be divided into different zones. As an alternative, at least two frying containers can be arranged in series. The foodstuff removed from the first frying container can be transferred into the following frying container, preferably continuously or at regular temporal intervals as a batch. For this transfer, a delivery from one frying container to a subsequent one can be provided, for example, to ensure a continuous frying process. In this manner, a spatial temperature profile is achieved wherein different temperatures can be set in the different zones or different frying containers. By means of the conveying speed through the individual zones of the foodstuff to be fried, the residence time of the foodstuff in the set temperature of the respective zone can be controlled.

In a continuous procedure it surprisingly turned out to be advantageous for the temperature of the zones to successively decrease in the moving direction. A successive decrease on the one hand ensures that the surface of the foodstuff to be fried obtains the desired crispy property. At the same time, the temperature is reduced, in the further method according to the predetermined temperature profile, to a degree that optimizes the maximum frying time and temperature and minimizes the formation of acrylamide and the absorption of fat.

A transport device for conveying the foodstuff along a moving direction through the at least one frying container can be provided. The transport device can include blades or belts. It is also possible to have the frying medium flow in the moving direction and have the foodstuff transported by the flowing frying medium in the process. To this end, a frying medium inlet in the region of the foodstuff supply and an outlet in the region of the foodstuff discharge can be provided, for example.

According to a further embodiment, the temperature in each zone can be kept constant. Each zone, whether it is a certain region in a frying container determined by the temperature of the frying medium, or a whole frying container, can thus be individually and in a controlled manner controlled to a temperature defined in the temperature profile. This permits to lower, in a simple way, the temperature of the frying medium in a controlled manner in accordance with the predetermined temperature profile.

According to one embodiment.the temperature can be, in particular during continuous frying, in the first zone in the moving direction at most 175° C., and in the last zone in the moving direction above 125° C. With a starting temperature of at most 175° C., the formation of acrylamide, for example in potato products, such as crisps or French Fries, can be avoided, and a lowering, in the moving direction, to above 125° C., preferably above 140° C., and particularly preferred above 150° C., that is controlled in accordance with the predetermined temperature profile, ensures that the frying process takes place as quickly as possible with a minimum absorption of the frying medium by the foodstuff.

To keep the temperature constant, the device according to the invention can include at least one sensor for detecting the temperature of the frying medium in the frying container. The at least one sensor can be connected with the control unit in a manner so as to transmit temperature data and thus permit an alignment of the actual temperature of the frying medium in the frying container with a predetermined desired temperature of the temperature profile in real time. In case of a deviation between the actual temperature and the desired temperature, the control unit can send a corresponding closed-loop control signal to the at least one temperature control device to compensate the deviation and to increase or decrease the temperature of the frying medium in the frying container. The design with various temperature zones within one frying container can comprise a plurality of sensors for temperature detection, for example one sensor in each of the zones of the frying container. A corresponding algorithm in the control unit verifies whether the measured temperature in the respective zone corresponds to the temperature zone correspondingly predetermined in accordance with the temperature profile at this time of the frying process. In this manner, a temperature control or a closed control loop for temperature control is possible.

The frying container can be designed to be temperature-controlled. The frying container can comprise, for example, one or more heating elements embodying its walls, for example its bottom in a temperature-controlled manner. One heating element per temperature zone can be present.

According to a further embodiment, the temperature control device can comprise at least one inlet at the frying container for previously temperature-controlled, i.e. pre-tempered frying medium. The frying container can furthermore comprise an outlet and a circulation device for the transport of frying medium from the outlet to the inlet of one zone. In this manner, the frying medium can be circulated, for example in each zone. The circulation of pre-tempered frying medium whose temperature is in particular higher than the temperature of the frying medium in the frying container has the advantage that the temperature of the frying medium can be quickly set and an internal temperature control device of the frying container can be supported. This is insofar advantageous as an internal temperature control device, in particular in case of the surprisingly distinct temperature drop at the beginning of the frying of permeabilized foodstuff. can be supported and the temperature can be very quickly brought again to the intended higher temperatures by adding externally pre-tempered frying medium.

In a method or device for continuously frying foodstuff wherein the temperature of the zones successively decreases in the moving direction, according to one embodiment, the frying medium removed from one zone can be introduced into a zone subsequent in the moving direction. This is in particular advantageous if the frying medium removed from the one zone serves as a pre-tempered frying medium of a subsequent zone, this means that the temperature of the removed frying medium is higher than the temperature in a subsequent zone to be set in accordance with the temperature profile. In order to achieve an effective closed-loop control, the transmission line by means of which the transport takes place from the outlet of one zone to the inlet of a subsequent zone can be fitted with a sensor for detecting the temperature of the circulated frying medium.

The temperature of the frying medium in the frying container altogether and in one zone can be controlled by the amount and/or the temperature of the frying medium flowing into the zone. In the device, a corresponding distributor, for example a flow valve, can be provided to this end. By means of corresponding sensors which measure the flow rate, the introduced amount can be controlled. The temperature control device can furthermore provide heat exchangers which enable the temperature in a circulation line or a buffer tank in which pre-tempered frying medium is stored. Moreover, collecting lines can be provided which collect the frying medium exiting from different outlets and transport it to a common storage or buffer tank.

The method according to the invention and the device according to the invention cannot only be used for continuous frying, but can also be employed to fry foodstuff discontinuously, that means as a batch method in one single container.

In discontinuous deep friers, by the supply of a cold product and the amount of energy required for the evaporation of the water, a surprisingly high temperature drop of the permeabilized foodstuff occurs at the beginning of the frying process. Conventional deep friers are not able to compensate this surprisingly sharp temperature drop by their heating devices. By the sharper temperature drop, a longer heating time is required which leads to the formation of undesired, thermally induced side products, such as acrylamide, and a considerable fat absorption. These disadvantages can be prevented according to the invention by the controlled lowering in accordance with a temperature profile. In the method in which the foodstuff is discontinuously fried, pre-tempered frying medium whose temperature is above the temperature of the frying medium in the frying container can be supplied to this end in order to support the heating power of the heating system of the deep fryer and to ensure a quick open-loop/closed-loop control to the temperature level predetermined in accordance with the temperature profile. The temperature of the pre-tempered frying medium can be above the temperature of the frying medium to be set in accordance with the temperature profile. The temperature of the pre-tempered frying medium can be, for example, just below the smoke point of the fried medium, but above the starting temperature, e. g. above 175° C.

In the discontinuous frying method, a temporal temperature profile is predetermined, wherein the frying medium is controlled temporally in the frying container in accordance with the temperature profile. In order to ensure this control, the frying medium can be circulated to this end, as was already described above with respect to a temperature zone in continuous operation. The supply of an externally pre-tempered frying medium into the frying container whose amount and/or temperature is controlled thus permits a discontinuous frying of foodstuff the cell membrane of which has been permeabilized.

In one embodiment in which the foodstuff is discontinuously fried, the starting temperature can be between 130° C. and 140° C., and/or the final temperature can be below 130° C., preferably below 125° C., and particularly preferred below 120° C.

The present invention permits to utilize the advantages of a discontinuous frying method, such as the known residence time, batch fidelity, declaration as "Kettlechips", also in permeabilized, e. g. electroporated foodstuff. The invention leads to a final product with a low degree of undesired browning reactions, low oil absorption, a reduction of the frying time and/or frying temperature, and a reduction of the heating time between two batches, and thereby to an increase of the production capacity.

Below, the invention will be described more in detail by embodiments with reference to the enclosed drawings by way of example. In the figures, elements that correspond to each other concerning their construction and/or function are provided with the same reference numerals. Combinations of features shown and described in the individual embodiments are only provided for illustration purposes. In accordance with the above statements, a feature of an embodiment may be omitted if its technical effect is not relevant for a certain application. Inversely, in accordance with the above statements, a further feature may be added to an embodiment if its technical effect is advantageous for a certain application.

In the drawing:

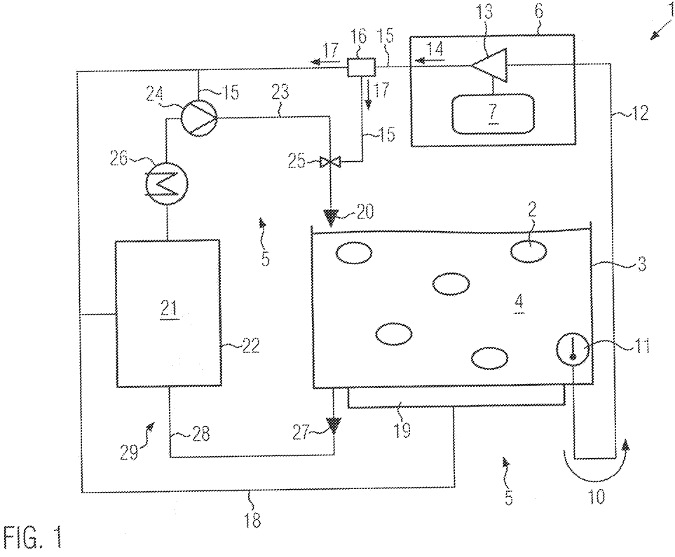

FIG. 1 shows a schematic representation of a device according to the invention for frying foodstuff according to a first embodiment;

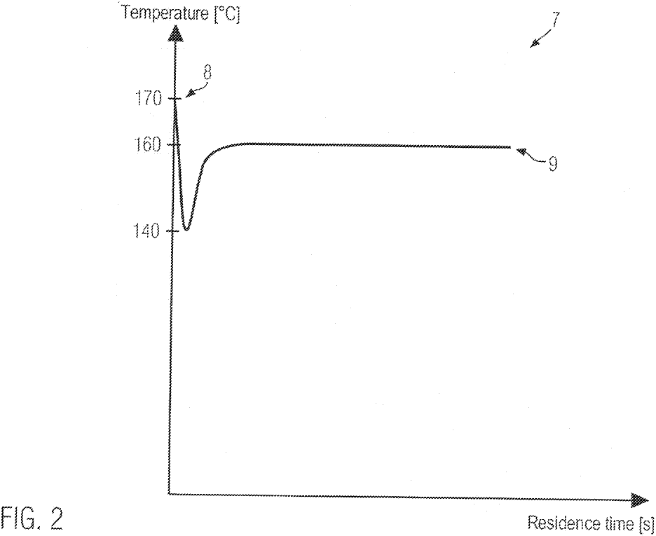

FIG. 2 shows a temperature profile according to a first embodiment which can be employed in the device according to FIG. 1;

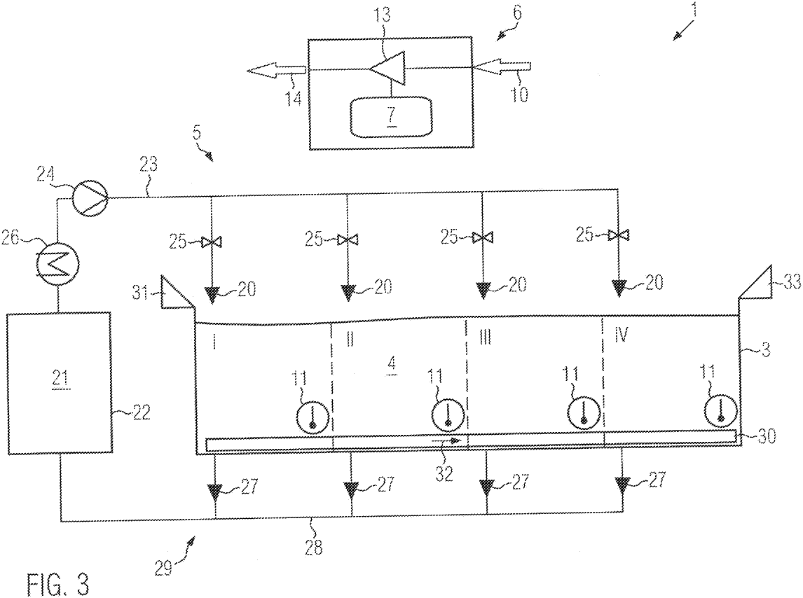

FIG. 3 shows a device according to the invention for frying food according to a second embodiment;

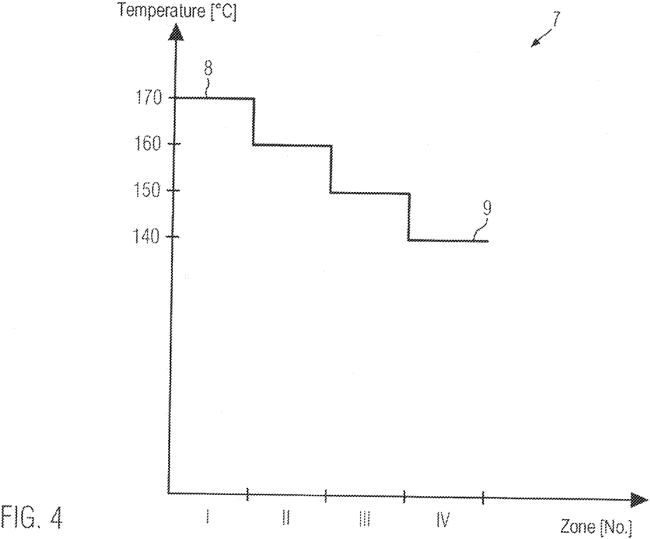

FIG. 4 shows a temperature profile which can be employed in the device according to FIG. 3;

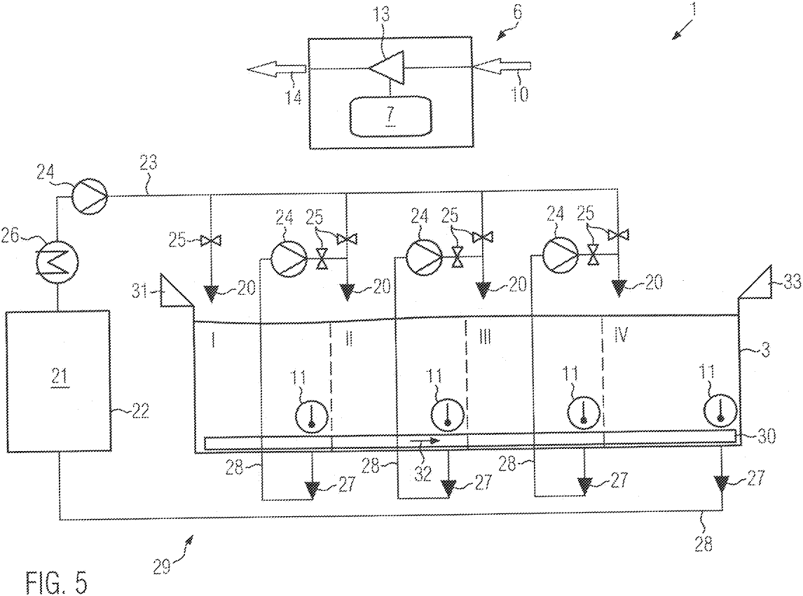

FIG. 5 shows a third embodiment of a device according to the invention for frying food; and

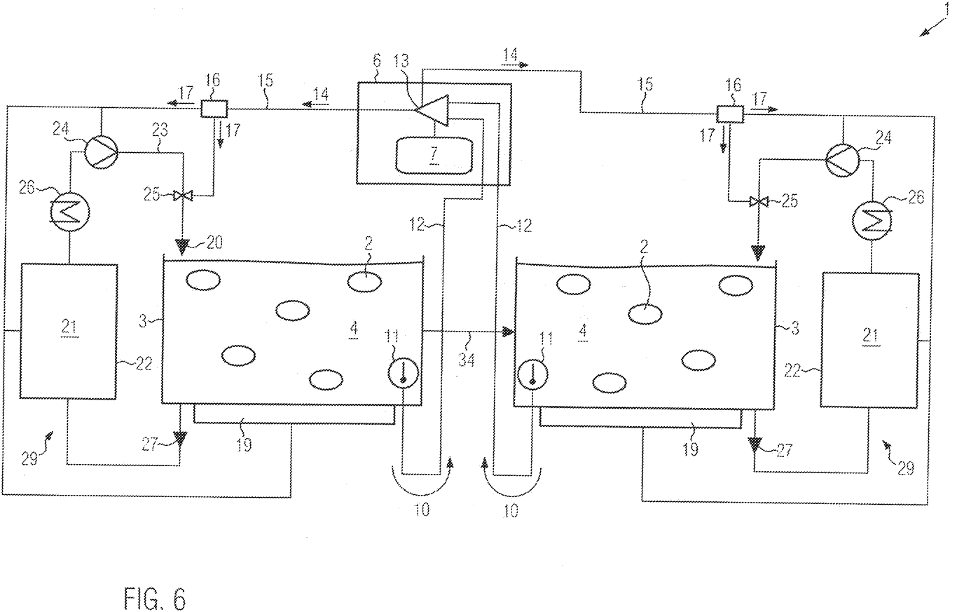

FIG. 6 shows a fourth embodiment of a device for frying foodstuff.

Below, exemplary devices and methods for frying a foodstuff the cell membrane of which has been permeabilized before frying according to the present invention are presented with reference to the figures.

A first embodiment of a device for producing a fried foodstuff is shown in FIG. 1, and a temperature profile used in said device is shown in FIG. 2.

The device 1 of FIG. 1 for producing a fried foodstuff 2 comprises a frying container 3 for receiving a frying medium 4 and the foodstuff to be fried 2. It comprises a temperature control device 5 for setting, that means increasing and/or lowering, the temperature of the frying medium 4 in the frying container 3. The device 1 furthermore comprises a control unit 6, for example an open-loop or closed-loop control unit, in which a temperature profile 7 with a starting temperature 8 and a final temperature 9 below the starting temperature 8 is stored. The control unit 6 is designed to send signals to the at least one temperature control device 5 and thereby set the temperature of the frying medium 4 in the frying container 3 in accordance with the temperature profile 7. Setting the temperature of the frying medium 4 in the frying container 3 in accordance with the temperature profile 7 means that the temperature of the frying medium 4 is set temporally and/or spatially in the frying container 3 in a controlled manner and is lowered from the starting 8 to the final temperature 9 as it is predetermined in the stored temperature profile 7.

In the embodiment of FIGS. 1 and 2, a temporal temperature profile 7 is employed in a device 1 which fries the foodstuff 2 discontinuously as a batch.

The device comprises a sensor 11 for detecting the temperature of the frying medium 4 in the frying container 3. The sensor 11 is designed to emit a temperature signal 10 and connected with the control unit 6 to transmit data via a temperature signal line 12, in fact to transmit the temperature signal 10. The transmission of the temperature signal 10 is indicated in FIG. 1 by an arrow. The signal line 12 can, of course, be accomplished both in a cable-based and a cable-less manner, for example by radio, infrared, WLAN or Bluetooth. The temperature signal 10 is received by the control unit 6 which controls the device such that the temperature of the frying medium 4 in the frying container 3 is set in accordance with the predetermined temperature profile 7. The temperature signal 10 is sent to a comparing means, i.e. a comparator 13 of the control unit 6 which compares the actual temperature of the frying medium 4, for which the emitted temperature signal 10 is representative, with the corresponding desired temperature value of the temperature profile 7. In case of a deviation, a closed-loop control signal 14 is emitted from the control unit via a closed-loop control line 15 to a closed-loop control unit 16. The closed-loop control unit takes appropriate measures to set the temperature of the frying medium 4 in the frying container 3 to the corresponding temperature value in accordance with the temperature profile 7.

As is obvious from the temporal temperature profile of FIG. 2, the starting temperature 8 is approximately 170° C. With the addition of the permeabilized foodstuff 2. the temperature of which is clearly below the starting temperature 8 before frying, this temperature initially decreases very sharply, but is very quickly set again to the desired final temperature 9 which is approximately 160° C. in accordance with the temperature profile 7.

During a discontinuous frying of foodstuff the cell membrane of which has been permeabilized, the high starting temperature 8 surprisingly sharply decreases to a range of approximately 140° C. upon the addition of the foodstuff 2. Only after the evaporation of the major portion of the water from the foodstuff 2, the temperature of the frying medium 4 rises again. Due to the surprisingly sharp temperature drop, conventional deep friers require a longer heating time until the desired final temperature 9 is reached. The longer heating time leads to undesired thermally induced side products, such as acrylamide, and an essentially higher absorption of frying medium 4 into the foodstuff 2.

In a non-depicted alternative method of discontinuous frying, in which the starting temperature is 130° C. to 140° C. and the final temperature is around 120° C., the temperature of the frying medium 4 also very sharply decreases when the foodstuff 2 is added, namely clearly below the final temperature to be set.

The device according to the invention acts against the sharp temperature drop and the slow heating by the predetermined temperature profile set to the sharp temperature drop and permitting a quick heating.

For the temperature control, the closed-loop control unit 16 can, for example, emit a heating signal 17 and emit it to a heating device 19 disposed at the frying container 4 via a heating signal line 18. The frying container itself can be designed to be temperature-controlled. In the shown embodiment, the heating device 19 is located at the bottom of the frying container. It could also be arranged in any other region of the walls of the frying container 4.

However, the heating power of a conventional heating element of a deep frier is usually not high enough to promptly compensate the surprisingly sharp temperature drop in the frying medium 4 invoked by the permeabilization of the foodstuff. According to the invention, in particular for discontinuous frying, a further temperature control device 5 is therefore provided which comprises an inlet 20 at the frying container 4 for pre-tempered frying medium 21. The pre-tempered frying medium 21 is stored in a storage container 22 which is connected with the inlet 20 via a fluid line 23. Within the fluid line 23, a pump 24 and a valve 25 are arranged, the valve metering the added amount of the pre-tempered frying medium 21 from the storage container 22 via the inlet 20 into the frying container 3.

The temperature of the pre-tempered frying medium 4 is usually above the starting temperature 8. In the shown embodiments, the temperature of the pre-tempered frying medium 21 is increased by a heat exchanger 26, among other things, arranged in the fluid line 23 Of course, the storage container 22 can also be provided with a heating device which brings the pre-tempered frying medium 21 to the desired temperature.

The temperature setting is mainly effected by the amount and/or the temperature of the pre-tempered frying medium 21 which is introduced into the frying container 4 via the inlet 20. In this manner, the temperature of the frying medium 4 in the frying container 3 can be very quickly set to the desired temperature in accordance with the temperature profile 7 despite the sharp temperature drop occurring at the beginning of the frying processin case of permeabilized foodstuff. To transmit a heating signal 17 from the closed-loop control unit 16 to the pump 24 and the valve 25, further closed-loop control lines 15 are provided. Furthermore, a closed-loop control line 15 could lead from the closed-loop control device 16 to the heat exchanger 26 or a heating device of the storage container 22 to increase the temperature of the pre-tempered frying medium 21, if required.

For the frying container 3 not to overflow, an outlet 27 is furthermore provided in the shown embodiment which is connected with the storage container 22 via a bypass line 28. The outlet can end in a collecting container. The device 1 shown in FIG. 1 contains a circulation device 29, comprising the outlet 27 via which frying medium 4 is removed from the frying container 3 and conducted into the storage container 22 via the bypass line 28. From the storage container, the pre-tempered frying medium 21 is returned again to the frying container 3 via the fluid line 23 and the inlet 20. The flow rate of the circulation device 29 can be set via the pump 24 and the valve 25.

By means of the device shown in FIG. 1, in which the temporal temperature profile 7 of FIG. 2 is stored in the control unit 6, a method according to the invention for frying the foodstuff 2 the cell membrane of which has been permeabilized can be carried out. In the process, the temperature of the frying medium 4 surrounding the foodstuff 2 is lowered from the starting temperature 8 at the beginning of the frying process to the final temperature 9 in a manner controlled in accordance with the predetermined temperature profile 7. The foodstuff is fried discontinuously in the shown embodiment and in the process, pre-tempered frying medium 21 is supplied to compensate the surprisingly sharp temperature drop at the beginning of the frying process. In the embodiment, the frying medium is circulated. By the circulation, via the amount and/or the temperature of the pre-tempered frying medium 21, the temperature of the frying medium 4 in the frying container 3 can be set to the predetermined temperature profile quickly and without being limited by the heating power of the deep frier.

In FIG. 3, a second embodiment of a device according to the invention for producing a fried foodstuff is shown. The temperature profile 7 stored in the control unit 6 of the second embodiment is represented in FIG. 4. Below, mainly the differences of the device 1 according to the second embodiment compared to the exemplary device of the first embodiment of FIG. 1 are discussed.

Thus, the signal line, the closed-loop control line, the closed-loop control device, the heating signal, and the heating signal line are omitted for a better overview in FIG. 3.

The device of FIG. 3 is designed for continuously frying the foodstuff. The device 1 comprises a frying container 3 which is divided into several, in the example four, temperature zones I to IV. The delimitations of the different temperature zones I to IV are represented by dashed lines. These are no partitions. Thus, the limits between the zones are floating.

To convey the foodstuff 2 through the individual zones I to IV of the frying container 3, a transport device 30 is provided. The transport device 30 conveys the foodstuff 2 from a foodstuff supply 31 along a moving direction 32. which is indicated by an arrow, successively through the temperature zones I to IV down to a foodstuff discharge 33 where the continuously fried foodstuff 2 is removed from the frying container 3. The transport device 30 is only represented schematically and can comprise, for example, blades or belts by which the foodstuff 2 is conveyed along the moving direction 32 through the different temperature zones I to IV.

In each temperature zone I to IV, a separate sensor 11 is arranged for detecting the temperature in the respective zone. Each temperature sensor 11 is configured to emit a temperature signal 10 characteristic of the temperature of the frying medium 4 in the corresponding temperature zone I to IV and to transmit it to the control unit 6.

The temperature profile 7 according to which the temperature of the frying medium is set according to the invention during the continuous frying of the foodstuff while the latter is being moved through the zones I to IV with different temperatures of the frying medium 4 in the moving direction 32 is shown in FIG. 4. In the present example, it is a stepped spatial temperature profile 7 where the temperature of the zones I to IV successively decreases in the moving direction 32. In the process, the temperature in the first zone I can be approximately 170° C., in the second zone II approximately 165° C., in the third zone III approximately 155° C., and in the fourth zone IV approximately 150° C. In the continuous frying process, water is initially removed at a high starting temperature, and the foodstuff is subsequently cooked well at low temperatures.

For the controlled setting of the desired temperature predetermined in accordance with the temperature profile 7 in the respective zone I to IV, the frying medium 4 is circulated in each one of the zones I to IV. To this end, in each of the zones I to IV, an inlet 20 for adding pre-tempered frying medium 21, and an outlet 27 for removing frying medium 4 are provided. The outlets 27 of the four zones end in a circulation line 28 which is designed as a collecting line and conducts any frying medium exiting from all four outlets 27 together into a storage container 22. To be able to constantly control the temperature in each zone I to IV individually and in a controlled manner to the temperature predetermined in accordance with the temperature profile 7, in the shown embodiment, each inlet 20 is under the control of a separate valve 25 by which the amount of the circulated frying medium 4 in the respective zone I to IV is controlled. Though it is not depicted in FIG. 3,each temperature zone I to IV can of course be provided with a separate circulation device 29, comprising a separate outlet 27, circulation line 28, storage container 22, pump 24, heat exchanger 26, fluid line 23 with a valve 25, and inlet 20. In this manner, one could not only individually control the added amount, but also the temperature of the pre-tempered frying medium 21 introduced into the respective zone I to IV.

The residence time of the foodstuff 4 in a temperature zone I to IV is set via the conveying speed of the transport device 30. Here, of course, not one single transport device 30 has to be provided which conveys the foodstuff 2 uniformly through all temperature zones I to IV. Instead, separate transport devices 30 can also be provided in each one of the zones I to IV. In this manner, the residence time of the foodstuff in the respective zones I to IV could be set individually and differently.

Below, a further embodiment of a device 1 according to the invention will be discussed with reference to FIG. 5. The device 1 shown in FIG. 5 largely corresponds to the device shown in FIG. 3. The temperature profile 7 which is employed in the control unit 6 of the device 1 shown in FIG. 5 corresponds to the temperature profile 7 of FIG. 4.

Below, the differences of the embodiment of FIG. 5 compared to the embodiment of FIG. 3 are discussed.

In the device 1 of FIG. 5, the outlets 27 are not connected to a collecting line, that means a collected bypass line 28 which connects the outlets 27 of all zones I to IV with the storage container 22. In the embodiment shown in FIG. 5, the frying medium 4 removed from one zone is introduced into a subsequent zone in the moving direction, in the exemplary embodiment into the directly following zone. The frying medium 4 removed from zone I via the outlet 27 is introduced again into the frying container 3 via the inlet 20 of zone II. To this end, a bypass line 28 from the outlet 27 is connected with the inlet 20 of the subsequent temperature zone. In the bypass line 28, a pump 24 and a separate valve 25 are arranged to control the amount of the circulated frying medium 4 transported from one zone into a subsequent zone. Analogous circulation devices 29 comprising a bypass line 28 with a pump 24 and a valve 25 take care of the circulation of frying medium 4 from zone II into zone III or zone III into zone IV. The outlet 27 in zone IV is connected with the storage container 22 via a bypass line 28. The pre-tempered frying medium 21 from the storage container 22 is conducted to the inlet 20 of the first zone.

In the moving direction 32, the inlets 20 of zones I to IV are each arranged at the beginning, and the outlets 27 at the end of the respective zone, shortly before the transition to the next zone. In this manner, the circulation of the frying medium supports the transport of the foodstuff in the moving direction 32 which can also accomplish an individual control of the residence time of the foodstuff in a zone I to IV. An embodiment in which frying medium is circulated from one zone into a subsequent zone is in particular suited for a continuous method for frying wherein the temperature in the zones successively decreases in the moving direction. In this manner, the warmer frying medium 4 of a preceding zone is transferred to a subsequent zone in which a lower temperature of the frying medium is to be set in accordance with the temperature profile 7. If the circulation of frying medium from one zone into a subsequent zone is not sufficient to set the desired temperature profile 7 in the frying container 3, additionally, pre-tempered frying medium 21 can be supplied from the storage container 22 to each of the inlets 20 via the fluid line, controlled by valves 25 and to a metered amount.

In a further, non-depicted embodiment, only one inlet 20 in the region of the foodstuff supply 31 and one outlet 27 in the region of the foodstuff discharge 23 could be provided. In this case, a mechanical conveyor means 30, for example in the form of blades or belts, could be omitted, and instead, the frying medium could be employed as a conveying medium which transports the foodstuff from the foodstuff supply 31 to the foodstuff discharge 30 by its circulation.

Finally, a fourth exemplary embodiment of the device 1 according to the invention will be discussed with reference to FIG. 6. The device 1 of FIG. 6 comprises two frying containers 3 which are arranged in series. A transfer device 34 is provided for transporting and transferring the foodstuff from the one frying container into the other one. The transfer device 34 is indicated in FIG. 6 only schematically by an arrow.

The device 1 of FIG. 1 is substantially a combination of two batch devices according to FIG. 1, wherein only one single control unit 6 is provided in which a temperature profile 7 is stored. In the comparator 13 of the control unit 6 of FIG. 6, the temperature signals 10 of the respective sensor 11 from the two frying containers 3 are received. These temperature signals 10 are compared with the predetermined values of the temperature profile 7 and, in case of a deviation of the actual value measured by the sensors 11 from the desired value predetermined by the temperature profile 7, a closed-loop control signal 14 is emitted to a closed-loop control unit 16 via a corresponding closed-loop control line 15. Here, each one of the two frying containers 3 arranged in series comprises a separate control loop with a separate closed-loop control unit 16, storage container 22 with a pre-tempered frying medium 21, circulation device 29 for adjusting a desired temperature of the pre-tempered frying medium 21 or the amount of the medium in the respective frying container 3.

### REFERENCE NUMERALS

1 device

2 foodstuff

3 frying container

4 frying medium

5 temperature control device

6 control unit

7 temperature profile

8 starting temperature

9 final temperature

10 temperature signals

11 (temperature) sensor

12 temperature signal line

13 comparator

14 closed-loop control signal

15 closed-loop control line

16 closed-loop control unit

17 heating signal

18 heating signal line

19 heating device

20 inlet

21 pre-tempered frying medium

22 storage container

23 fluid line

24 pump

25 valve

26 heat exchanger

27 outlet

28 bypass line

29 circulation device

30 temperature control device

31 foodstuff supply

32 moving direction

33 foodstuff discharge

34 transfer device

I first temperature zone

II second temperature zone

III third temperature zone

IV fourth temperature zone

1. Method for frying a foodstuff (2) the cell membrane of which has been permeabilized, wherein the temperature of a frying medium (4) surrounding the foodstuff (2) is lowered from a starting temperature (8) at the beginning of the frying process to a final temperature (9) in a manner controlled in accordance with a predetermined temperature profile (7).

2. Method according to claim 1, wherein the foodstuff (2) is continuously fried and in the process moved along a moving direction (32) through zones (I to IV) with different temperatures of the frying medium (4).

3. Method according to claim 2, wherein the temperature of the zones (I to IV) successively decreases in the moving direction (32).

4. Method according to claim 2, wherein the temperature in each zone (I to IV) is kept constant.

5. Method according to claim 2, wherein the temperature in the first zone (1) in the moving direction (32) is at most 175° C., and is in the last zone (IV) in the moving direction (32) above140° C.

6. Method according to claim 2, wherein the temperature of the frying medium (4) in one zone (I to IV) is controlled by the amount and/or the temperature of the frying medium flowing into the zone (I to IV).

7. Method according to claim 2, wherein the frying medium (4) is circulated in each zone (I to IV).

8. Method according to claim 2, wherein the frying medium (4) removed from one zone (I to III) is introduced into a subsequent zone (II to IV) in the moving direction (32).

9. Method according to claim 1. wherein the foodstuff (2) is discontinuously fried and pre-tempered medium (21) is supplied in the process.

10. Method according to claim 1, wherein the frying medium (4) is circulated.

11. Device (1) for producing a fried foodstuff (2), in particular for performing the method according to claim 1, which comprises at least one frying container (3) for receiving a frying medium (4) and the foodstuff (2) to be fried, at least one temperature control device (5) for setting the temperature of the frying medium (4) in the frying container (3), and a control unit (6), in which a temperature profile (7) with a starting temperature (8) and a final temperature (9) below the starting temperature (8) is stored, wherein the control unit (6) is adapted to send temperature signals (10) to the at least one temperature control device (5) and thereby set the temperature of the frying medium (4) in the frying container (3) in accordance with the temperature profile (7).

12. Device (1) according to claim 11, comprising at least one sensor (11) for detecting the temperature of the frying medium (4) in the frying container (3).

13. Device (1) according to claim 11, wherein the temperature control device (5) comprises at least one inlet (20) for pre-tempered frying medium (21).

14. Device (1) according to claim 11, further comprising a transport device (30) for conveying the foodstuff (2) along a moving direction (32) through the at least one frying container (3), wherein the frying container (3) is preferably divided into at least two zones (I to IV).

15. Device (1) according to claim 11, wherein at least two frying containers (3) are arranged in series.

16. Method according to claim 3, wherein the temperature in each zone (I to IV) is kept constant.

17. Method according to 3, wherein the temperature in the first zone (I) in the moving direction (32) is at most 175° C., and is in the last zone (IV) in the moving direction (32) above 140° C.

18. Device (1) according to claim 12, wherein the temperature control device (5) comprises at least one inlet (20) for pre-tempered frying medium (21).

19. Device (1) according to claim 12, further comprising a transport device (30) for conveying the foodstuff (2) along a moving direction (32) through the at least one frying container (3), wherein the frying container (3) is preferably divided into at least two zones (I to IV).

20. Device (1) according to claim 12, wherein at least two frying containers (3) are arranged in series.
